(19) United States
(12) Patent Application Publication
(10) Pub. No.: US 2009/0049143 A1
(43) Pub. Date: Feb. 19, 2009

(54) System and method for transmitting messages for a set of communication devices

(76) Inventor: Aline Tarrago, Sceaux (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/887,156

(22) PCT Filed: Mar. 21, 2006
(86) PCT No.: PCT/FR2006/050246

§ 371 Date: Sep. 24, 2007

(30) Foreign Application Priority Data
Mar. 22, 2005 (FR) 0502803

(51) Int. Cl. G06F 15/16

(52) U.S. Cl. 709/206

(57) ABSTRACT

A method for transmitting messages for at least one predefined set of communication devices (10, 10′, 10″), said devices corresponding to subscribers to a private network management service, by means of a service platform (11), wherein said method comprises the steps of: creating at least one private network of communication devices (10, 10′, 10″) from a first communication device (10); transmitting via said first communication device (10) to said platform (11) at least one list of communication devices (10′, 10″), identified and included in said private network; receiving via said platform (11) at least one message for requesting entry into said private network originating from each of said identified communication devices (10′, 10″) of said private network; transmitting to said set of communication devices (10′, 10″) via said platform (11) at least one message for creating said private network; and after validation, transmitting at least one message in said private network from and/or to said identified communication devices (10, 10′, 10″) according to at least one transmission rule, while retaining the anonymity of the members of said private network.

The present invention relates to a system and a method for transmitting messages for at least one predefined set of communication devices by means of a platform.

The invention finds a particularly advantageous application in the field of filtered and secure transmission of messages to terminals of a private network from a communication device.

The prior art divulges discussion and interchange groups on the Internet network which, by means of an electronic mail service, make it possible to put the members of a group in contact, to share and interchange information and to manage events. The members contact the group via electronic messages (email or instantaneous messaging), and add events and documents that can be consulted by all the members of the group.

However, these known discussion groups usually have the disadvantage of being accessible to everyone. Any user subscribed to discussion groups may choose to enter a group, whose center of interest concerns him, or to create a new group. Consequently, a discussion group may comprise a large number of members. Since all the members of a discussion group may send messages, propose events, etc., and know the coordinates of the other members of said group, the management of these groups is difficult to organize. As a result, the members of a group receive solicitations without having requested them. The members of the group add themselves or remove themselves without taking account of the members that already exist. Since there are no predefined access conditions, the newly entering members participate in the discussion group with no filtering.

In this sense, it is possible to evoke the personal contact networks that consist of people who know one another, have common centers of interest or are close physically such as neighbors or affectively such as the members of a family. The members of said network come into contact and act together only by common agreement.

It will be noted nevertheless that the communication and the interchanges within these personal contact networks, although private, are not protected from access by third parties. In addition, usually, for the members of the network to act together, one of the members must first approach the other members. This approach depends on the goodwill of one of the members of the network and is carried out freely without prior organization or predefined to conditions.

Also, a technical problem to be resolved by the subject of the present invention is to propose a method for transmitting messages for at least one predefined set of communication devices, said devices corresponding to subscribers to a private network management service, by means of a service platform, which would make it possible to remedy the disadvantages of the existing systems and would allow a filtered transmission of said messages taking account of predefined operating and transmission rules.

The solution to the technical problem consists, according to the present invention, in that said method comprises the steps consisting in:

creating at least one private network of communication devices from a first communication device,

transmitting via said first communication device to said platform at least one list of communication devices, identified and included in said private network,

receiving via said platform at least one message for requesting entry into said private network originating from each of said identified communication devices of said private network,

transmitting to said set of communication devices via said platform at least one message for creating said private network,

after validation, transmitting at least one message in said private network from and/or to said identified communication devices according to at least one transmission rule.

The invention also relates to a system for transmitting messages for at least one predefined set of communication devices, said devices corresponding to subscribers to a private network management service, by means of a service platform, characterized in that said system comprises at least one first communication device, included in said set of terminals, capable of creating at least one private network, without sending a message to said communication devices, and of defining a list of communication devices, included in said private network, and at least one rule for said private network, said creation being validated by said platform only after receipt of at least one entry request message corresponding to said private network originating from each of said communication devices of said set.

Thus, the system and the method according to the invention allow the transmission of filtered messages in a closed private network, consisting of a predefined set of communication devices. The private network is validated only after the transmission by all said terminals of at least one entry request message, in order to protect the number of communication devices accepted in a private network.

The list of the members of a private network is proposed from a first communication device. All the proposed members must request entry into said private network and confirm their agreement to the operating and transmission rules within said private network.

The members of the private network are therefore assured that they will receive no message from unpredefined communication devices. The rules, placed in memory, prevent all messages except those defined for said private network. The private network, according to the invention, allows interchanges in total confidence within a circle of restricted and selected members.

According to the invention, said private network is created by a manager entity of said set.

Similarly, the invention provides that said list of communication devices included in said private network and said rule is defined by said manager entity.

The invention also provides that only said manager entity modifies said list of terminals included in said private network and said rule.

It is understood that, in this manner, the system and the method that are the subject of the invention allow a centralized and secure management by a single manager entity. The manager entity provides the rules within the private network, rules having been accepted by the communication devices of said private network.

An advantageous feature of the method according to the invention consists in that it also comprises a step of filtering by said platform of the messages originating from at least one sending entity external to said private network.

The description that follows with respect to the appended drawing, given as a nonlimiting example, will clearly explain what is involved in the invention and how it can be embodied.

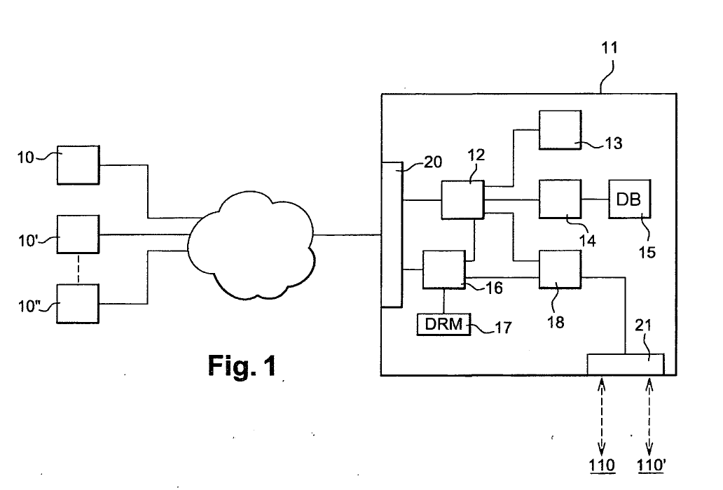

FIG. 1 represents the general architecture of a system for transmitting messages for at least one predefined set of communication devices, said devices corresponding to subscribers to a private network management service, by means of a service platform, according to the invention.

A user is subscribed to a private network management service with a telecommunications operator. He is connected to a telecommunications network of said operator, from a first communication device 10 represented in FIG. 1.

The user wishes to create at least one private network for a set of communication devices to be defined. The user connects to a private networks service platform 11 from the first communication device 10 via a communication interface 20. He selects the function for proposing a private network and identifies said private network by recording an identifier X and an object Z representing said private network. The identifier X of the private network may be the name and/or the forename of the user who creates the private network. But, the identifier X may be the chairman of an association, the name of a club or that of an educational establishment, etc. If there is no identifier, the service platform 11 identifies said private network thanks to the first communication device 10, connected to said platform 11 via a high bit rate cable, for example by high bit rate ADSL (Asymmetric Digital Subscriber Line) transmission.

The object Z makes it possible to know the purpose of creating the private network. It may be a personal interest (health, employment, etc.), a common center of interest such as soccer or chess, the activity of the association or of the club such as a neighborhood committee or library, or else school work.

The communication device 10 is authenticated in a nondeclarative and automatic manner, without intervention of the user. The implicit authentication may be compatible with the recommendations of the Liberty Alliance enterprise consortium or else of the single authentication technologies such as Single Sign-On (or SSO).

When a new private network has been identified (X, Z), at least one management module 12, in said private networks service platform 11, automatically stores the creator of the private network as the manager entity of said private network.

Said manager entity carries out the referencing of each of the terminals associated with said communication device 10, for example the mobile telephone number of each person in the family, the identification number of the existing television sets and personal computers or PCs, laptop computers, personal digital assistants or PDAs, etc.

In this manner, said management module 12 places in memory the type of messages compatible with each of said terminals, such as a voice message, a text file, a message for an electronic mail service or email, a video message, an audiovisual content, etc.

In the example described, the manager entity is the user himself, but the information may be transmitted during the subscription (or other) to the telecommunications operator who places all the received information in memory in at least one database 15 that can be accessed via the private networks service platform 11.

Then, the manager entity defines a list of communication devices included in the proposed private network (X, Z), without sending any message to said communication devices 10′, 10″. It identifies all the members, subscribers to said service, that will be included in said private network. Each of these members must be equipped with a communication device 10, 10′, 10″ or else an application, compatible for a communication with the platform 11, is installed in an item of equipment or a terminal authenticated by said private networks service platform 11. Said list is transmitted by the first communication device 10 to the service platform 11.

The referencing of said private network (X, Z) may be carried out and placed in memory by the operator who manages the service platform 11. An external manager entity may, for example, be responsible for the referencing of the various sets of terminals.

Said communication devices 10, 10′, 10″ of the private network are authenticated in a nondeclarative and automatic manner, without intervention of the user, in order to retain the anonymity of the members of the private network. The implicit authentication may also be compatible with the recommendations of the Liberty Alliance enterprise consortium or else of the single authentication technologies such as Single Sign-On (or SSO) or any other nondeclarative authentication.

Finally, the manager entity also defines at least one applicable rule for said private network (X, Z). Various rules are usually predefined and accessible from the platform 11 by the first communication device 10, which selects from said proposed rules. As mentioned above, the referencing of the terminals may for example be carried out by an operator as the manager entity, as can the predefined rules. The user, as another manager entity, may then also define particular rules or other elements.

Said rules are transmitted by said first communication device 10 to said service platform 11. Irrespective of the definition mode, the defined rules determine the conditions of operation and transmission for said private network.

For example, in a nonexhaustive manner, the rules to be selected for the private network may provide criteria of accessibility to the transmitted messages, access to external contents, authorization to create an event, removal or addition within the private network, organization of a sharing, etc. The manager entity must select from the predefined rules in order to organize the operation and the transmissions for said private network (X, Z).

For example, in addition to the messages transmitted between the various communication devices of the private network (X, Z), only the manager entity may have access to entities external to said private network, for example in order to download a content shared in the private network. Depending on the parameter settings, the manager entity may also define a list of external sending entities 110, 110′, having access to said private network, for example only originating from external partners listed in the field of games, audiovisual programs, health and employment. Said sending entities may enter into contact with the platform 11 via access providers of any kind (fixed or mobile network, Internet network or any other communication network) by means of at least one access interface 21 and at least one access module 18.

It may also select that the private contents, created from one of the communication devices of the private network, may be shared and accessible to everyone. On the other hand, the contents transmitted by the external partners, previously listed by the manager entity, are managed only by said manager entity.

For the messages transmitted within said private network (X, Z), the conditions of transmission also include at least one criterion of accessibility, which is defined by the manager entity according to the nature of the messages. There are 3 accessibility criteria, which are a free accessibility to a message, a personal accessibility and a confidential accessibility. The free accessibility may be reserved for a message to all the communication devices 10, 10′, 10″ of said private network, that is to say that a message sent by one of the terminals to all the communication devices 10, 10′, 10″ of the private network is automatically transmitted by a voice message to the communication devices and can be accessed by everyone. For example, in the case of a general request, such as to go and collect the children from school because of unavailability or else organize a collective broadcast of digital photos.

A message from one communication device to one or more communication devices 10, 10′, 10″ of the private network (X, Z) is for example transmitted with a personal accessibility, that is to say that it is transmitted to the receiving communication device, but the communication devices of the private network are aware of the receipt of a personal message in the name of the recipient without having access to said message.

The messages originating from said external sending entities 110, 110′ for the games and the audiovisual programs listed by the manager entity are, for example, transmitted with a personal accessibility, that is to say that they are automatically transmitted only to said first communication device 10 in the name of said manager entity. Therefore, only the manager entity may decide to share a content transmitted by said external sending entities 110, 110′.

The messages originating from the external sending entities listed in the field of health and employment may be transmitted with a confidential accessibility, that is to say that they are transmitted only to a terminal referenced by the manager entity as being the terminal intended for the confidential messages. The communication devices of the private network (X, Z) have no knowledge of the receipt of a confidential message and therefore have no access thereto.

According to a first example of rule definition, only the manager entity of the private network (X, Z) may modify, add or remove a communication device according to the same method of entry request, and of confirmation if it exists. Only the manager entity may add or remove a content or else authorize the addition of a content originating from one of the communication devices or organize a sharing or an event for all or a portion of the communication devices in said private network (X, Z). According to the parameter setting, only the manager entity defines the list of the external sending entities 110, 110′ having access to the private network (X, Z).

Said manager entity of the private network (X, Z) checks all the actions carried out within said private network (X, Z) which makes the management of the latter easier. This definition mode corresponds to a private network (X, Z) called “closed”, in which the number of communication devices is usually limited, in which the contents are personal and in which the relations are private.

According to another particular example of rule definition, for example in the case of a private network corresponding to an association or to a library etc., all the communication devices may be authorized to organize a sharing with all or a portion of the communication devices in said private network. This definition mode corresponds to a private network called “shared”, in which the number of communication devices is also limited, in which the contents usually originate are from external partners and in which the relations are those of a common interest.

According to another particular example of rule definition, all the communication devices of a private network called “open” may organize a sharing or add a content, in order to allow debates with a limited number of communication devices in a subgroup. On the other hand, only the manager entity of said “open” private network may remove a content or else add or remove a communication device. The manager entity may be a group of members of the private network. For this mode of definition corresponding to an “open” private network, the number of communication devices may be large, and they may on occasion form subgroups inside the “open” private network for the duration of a particular sharing. The contents may be various and of any nature, originating from external partners, from associations, from clubs, etc.

The service platform 11 may place in memory the category of the private network, either closed or shared or open, with the corresponding rights. On each action of one of the communication devices of a private network, the management module 12 may verify the rights according to the category of said private network.

Said first communication device 10 has therefore allowed the creation of a private network and the definition of the list of the communication devices 10′, 10″ included in said private network, and rules for said private network, without sending a message to said communication devices 10′, 10″. The communication devices 10′, 10″ proposed for entering said private network are included only after validation of the creation of said private network by the service platform 11.

The proposed new private network (X, Z), that is to say the list of the communication devices 10, 10′, 10″ of said private network and the rules, is placed in memory by the private networks service platform 11, without sending a message to said communication devices 10′, 10″. This information is held in abeyance until the receipt of entry request messages corresponding to said proposed private network.

Now, the user who wishes to create said private network (X, Z), will have to enter into contact with all the members listed in the private network (X, Z) in order to tell them to request entry into said private network (X, Z). To do this, he may meet physically, telephone, send an email to, etc., each of the members, giving them the identifier X, if it exists, and the object Z of the proposed private network.

Each of the proposed members, a subscriber to the service and equipped with a communication device 10′, 10″, connects to said private networks service platform 11 and sends a message to request entry into said private network (X, Z) from a communication device. The service platform 11 receives a message to request entry into said private network (X, Z) originating from all the communication devices 10′, 10″, predefined by the manager entity of said private network.

Said private networks service platform 11, receiving all the entry request messages (X, Z), compares said entry request messages (X, Z) with the list of the communication devices proposed by said manager entity of the private network (X, Z). So long as the proposed list and the entry request messages (X, Z) of all the communication devices of the list are not received, the information remains in abeyance and said private network (X, Z) is not validated.

When said comparison is positive, the management module 12 of the platform 11 transmits a message for the creation of the private network (X, Z) to said set of communication devices 10, 10′, 10″, that is to say to all the members of said private network (X, Z) including to the manager entity. Said private network creation message, having as its identifier X, if it exists, and as its object Z, comprises the applicable rules for the private network (X, Z).

According to the parameter setting, said creation message may comprise a request for each of the communication devices of said private network to send a confirmation message. On receipt of all the confirmation messages originating from said set of communication devices, the network (X, Z) is validated by the private networks service platform 11.

The creation of the private network (X, Z) is therefore validated by the platform 11 only after receipt of all the entry request messages and, if they exist, the confirmation messages, corresponding to said private network originating from all of said communication devices 10, 10′, 10″ of the private network.

After the validation of the private network (X, Z), the messages are transmitted in said private network according to the rules defined by the manager entity.

Said communication devices 10, 10′, 10″ of the private network are authenticated in a nondeclarative and automatic manner, without intervention of the user, in order to retain the anonymity of the members of the private network. Since the terminals of said private network are referenced, they are recognized by the platform 11. As soon as one of said terminals is started up, the platform 11 detects the presence of said terminal for the acknowledgement of a transmission to said terminal, for example based on the transmission of instantaneous messages (such as Instant Messaging).

Based on the validation of the private network (X, Z), as soon as the communication devices 10, 10′, 10″ of said private network (X, Z) are started up, the messages with a criterion of free accessibility are automatically transmitted in voice mode by the service platform 11 to all said communication devices 10, 10′, 10″. All the communication devices that have received a free accessibility message are automatically notified that one of the communication devices has responded to said message.

Said messages are automatically transmitted in real time between the communication devices 10, 10′, 10″ of the private network (X, Z), which are assured of receiving no undesired message. The rules placed in memory prevent all the messages except those defined by the operating rules of said private network (X, Z). They allow interchanges in full confidence within a circle of restricted, personalized and selected members.

In addition, all the members of the private network are equipped with a communication device 10, 10′, 10″, which is automatically authenticated by a high bit rate connection to the service platform 11. Since the manager entity has referenced all the terminals associated with said communication device, the platform 11 carries out an implicit and automatic authentication on each connection of a terminal. This referencing of the terminals allows a nondeclarative authentication, without intervention of the user. This authentication allows a limited transmission of the messages only to the identified senders, while retaining the anonymity of the members of the private network.

The implicit authentication may be compatible with the recommendations of the Liberty Alliance enterprise consortium or else of the single authentication technologies such as Single Sign-On (or SSO) or any other nondeclarative authentication.

Once the referencing has been performed, each of the terminals of said set is recognized by the platform 11. As soon as one of said terminals is started up, the platform 11 detects the presence of said terminal for the inclusion of a transmission to said terminal, for example based on the transmission of instantaneous messages (such as Instant Messaging).

The manager entity of the private network (X, Z) may create an event and propose it to the members of said private network (X, Z). The event may be, for example, to watch a sporting event, to which said manager entity is subscribed through a pay channel, simultaneously sharing the broadcast of the audiovisual content and a voice communication making it possible to make comments, or to broadcast personal digital photographs with the corresponding explanations or else to project slides proposed by a teacher with a voice communication with pupils in order to simultaneously produce the report of the projection by the pupils.

Each of the members therefore remains close to a communication device, for example at his home, while being connected in a privileged and filtered manner via a voice or text or videophone communication with the other identified communication devices of said private network.

The private networks service platform 11 makes it possible to set up the relation between the members over time and to save said predefined relations via a manger entity of said private network, with monitoring and possible statistics for measuring the use of the services provided.

A professional, who subscribes to the service and is equipped with a communication device or an application compatible with the platform 11 installed in an item of equipment or a terminal, may be the initiator and propose the creation of a private network, for example in the case of a private network around the health of a patient. Said patient, himself a subscriber to the service and equipped with a communication device, is then the manager entity of said private network, containing various health professionals, for example in order to share a medical file in full confidence.

A user, who subscribes to the service and is equipped with a communication device 10, 10′, 10″ or with a compatible application, may be a member or a manager entity of several different private networks, depending on the participants (family, friends, neighbors, pupils, club, etc.) or depending on the object (health with various professionals, employment agency in order to look for a job, soccer fans or chess players, school work, etc.).

All the communication devices or applications compatible with said platform 11 allow access to the information placed in memory by the platform, such as the private networks, the rules, etc., corresponding to said communication device 10, 10′, 10″. For example, a communication device 10, 10′, 10″ may have access to the list of all the validated private networks for which it is the manager entity, by means of at least one private network module 14 and at least one archiving module 13.

Within the private network (X, Z), the messages are transmitted by the service platform 11 according to the transmission conditions and criteria of accessibility and according to the nature of the messages and their content (voice, text, email, audiovisual, etc.) to a terminal associated with the communication device 10, 10′, 10″, referenced by said manager entity of said private network (X, Z).

Except for the validated list of the communication devices 10, 10′, 10″, all the other subscribers to the service have no access to said private network (X, Z) validated by the private networks service platform 11.

According to the invention, the service platform 11 is therefore responsible for the following functionalities, taken separately or in combination:

administration of the private networks and of the lists of communication devices 10, 10′, 10″ included in said private networks, by at least one management module 12 and by at least one private network module 14 by means of a communication interface 20,

placing in memory of at least one rule for said private networks, thanks to at least one database 15,

control and filtering of the external sending entities 110, 110′, having access to said private networks, and access to their services by means of at least one access interface 21, an access module 18 and an authentication module 16,

nondeclarative and automatic authentication, without intervention of the user, of all the communication devices 10, 10′, 10″ by means of said authentication module 16,

real-time monitoring of the communications and the presences, and saving of this information by means of an archiving module 13 in order to produce statistics for measuring the use of the services provided.

Said service platform 11 also allows the following functionalities, taken separately or in combination:

checking of all the manager entities and of all the communication devices 10, 10′, 10″ or of the compatible applications subscribed to the platform 11,

management of all the access rights, in particular the intellectual property rights, by means of a DRM (Digital Rights Management) module 17, which allows access to contents transmitted by the external sending entities to be managed,

placing in memory in at least one database 15 of the identification tables, the rules, the conditions of operation and transmission, in particular of the criteria of accessibility, of the communication devices and of the associated terminals, of the private networks.

Said communication device 10 is equipped at least with one user interface, with transmission and reception viewing and broadcasting means, for example a touch-screen or a screen/keyboard, said communication device 10 being capable of creating at least one private network and of defining at least one operating rule and conditions for transmission of the messages transmitted via said private network.

According to the invention, the main functions of the communication device 10 are the following, taken separately or in combination:

interface for access to at least one message, taking account of the various criteria of accessibility to the messages, and to the services of the platform 11,

receipt of simultaneous communications in voice or text mode,

detection of proximity of terminals, for example in the case of a confidential message that must be broadcast to a mobile terminal located in the same radio cell as said communication device 10,

detection of presence of the users of the communication device, for example by a biometric device that detects contact of the hand of a user for the startup of said communication device 10 and the automatic broadcasting of the free accessibility messages.

A method for transmitting messages using the system of FIG. 1 comprises the following steps consisting in:

creating at least one private network of communication devices 10, 10′, 10″ from a first communication device 10,

transmitting via said first communication device 10 to said platform 11 at least one list of communication devices 10′, 10″, identified and included in said private network,

receiving via said platform 11 at least one message for requesting entry into said private network originating from each of said identified communication devices 10′, 10″ of said private network,

transmitting to said set of communication devices 10′, 10″ via said platform 11 at least one message for creating said private network,

after validation, transmitting at least one message in said private network from and/or to said identified communication devices 10, 10′, 10″ according to at least one transmission rule.

The method according to the invention provides a step of filtering by the service platform 11 of the messages originating from, an external sending entity 110, 110′ to said private network, for the creation of a private network or quite simply for the broadcasting of messages by said private network.

The system and the method according to the invention therefore allow a creation request by a manager entity of a private network consisting of a predefined set of terminals and managed by a service platform. The latter places in memory the request to create the private network and the rules that are the conditions of operation and of transmission of the messages by said private network.

The members of a private network also transmit to the service platform a request message to enter said private network. Said private network is validated by the platform only after receipt of all the requests concerning said private network. Via this active approach, the number of members is checked for each private network. Filtering conditions are also placed in memory by the platform for access of the external sending entities. Consequently, within a private network, no unauthorized intrusion is possible except for the identified senders that can communicate in total confidence.

1. A method for transmitting messages for at least one predefined set of communication devices (10, 10′, 10″), said devices corresponding to subscribers to a private network management service, by means of a service platform (11), wherein said method comprises the steps of:
creating at least one private network of communication devices (10, 10′, 10″) from a first communication device (10);
transmitting via said first communication device (10) to said platform (11) at least one list of communication devices (10′, 10″), identified and included in said private network;
receiving via said platform (11) at least one message for requesting entry into said private network originating from each of said identified communication devices (10′, 10″) of said private network;
transmitting to said set of communication devices (10′, 10″) via said platform (11) at least one message for creating said private network; and
after validation, transmitting at least one message in said private network from and/or to said identified communication devices (10, 10′, 10″) according to at least one transmission rule, while retaining the anonymity of the members of said private network.

2. The method as claimed in claim 1, further comprising a step of filtering by said platform (11) of at least one message originating from at least one sending entity external to said private network.

3. The method as claimed in claim 1, wherein said private network is created by at least one manager entity of said set.

4. The method as claimed in claim 1, wherein said list of communication devices (10′, 10″), included in said private network, and said rule are defined uniquely by said manager entity.

5. The method as claimed in claim 1, wherein only said manager entity defines at least one list of the external sending entities having access to said private network.

6. The method as claimed in claim 1, wherein said rule includes at least one criterion of accessibility to said messages.

7. The method as claimed in claim 6, wherein said criterion of accessibility is a free accessibility to said messages.

8. The method as claimed in claim 6, wherein said accessibility criterion is a personal accessibility to said messages.

9. The method as claimed in claim 6, wherein said criterion of accessibility is a confidential accessibility to said messages.

10. The method as claimed in claim 1, wherein only said manager entity modifies said list of communication devices (10, 10′, 10″), included in said private network and said rule.

11. A system for transmitting messages for at least one predefined set of communication devices (10, 10′, 10″), said devices corresponding to subscribers to a private network management service, by means of a service platform (11), wherein said system comprises at least one first communication device (10), included in said set of terminals, capable of creating at least one private network, without sending a message to said communication devices (10′, 10″) in order to retain the anonymity of the members of said private network, and of defining a list of communication devices (10′, 10″), included in said private network, and at least one rule for said private network, said creation being validated by said platform (11) only after receipt of at least one entry request message corresponding to said private network originating from each of said communication devices (10, 10′, 10″) of said set.

12. A platform for using the method as claimed in claim 1 and a system for transmitting messages for at least one predefined set of communication devices (10, 10′, 10″), said devices corresponding to subscribers to a private network management service, by means of a service platform (11), wherein said system comprises at least one first communication device (10), included in said set of terminals, capable of creating at least one private network, without sending a message to said communication devices (10′, 10″) in order to retain the anonymity of the members of said private network, and of defining a list of communication devices (10′, 10″), included in said private network, and at least one rule for said private network, said creation being validated by said platform (11) only after receipt of at least one entry request message corresponding to said private network originating from each of said communication devices (10, 10′, 10″) of said set;
wherein said platform (11) is configured at least for the following:
administration of the private networks and of the lists of communication devices (10, 10′, 10″), included in said private networks;
placing in memory of at least one rule for said private networks;
filtering of the external sending entities having access to said private networks; and
the nondeclarative and automatic authentication of all the communication devices (10, 10′, 10″).

13. A communication device for using the method as claimed in claim 1, and a system for transmitting messages for at least one predefined set of communication devices (10, 10′, 10″), said devices corresponding to subscribers to a private network management service, by means of a service platform (11), wherein said system comprises at least one first communication device (10), included in said set of terminals, capable of creating at least one private network, without sending a message to said communication devices (10′, 10″) in order to retain the anonymity of the members of said private network, and of defining a list of communication devices (10′, 10″), included in said private network, and at least one rule for said private network, said creation being validated by said platform (11) only after receipt of at least one entry request message corresponding to said private network originating from each of said communication devices (10, 10′, 10″) of said set;
wherein said communication device (10, 10′, 10″) comprises at least one interface for access to at least one message, taking account of the different criteria
for accessing the messages, in order to retain the anonymity of the members of said private network.
